(19) United States
(12) Patent Application Publication
(10) Pub. No.: US 2009/0198699 A1
(43) Pub. Date: Aug. 6, 2009

(54) REMOTE SPACE EFFICIENT REPOSITORY

(75) Inventors: Mario F. Acedo, Tucson, AZ (US); Ezequiel Cervantes, Tucson, AZ (US); Paul A. Jennas, II, Tucson, AZ (US); Jason L. Peipelman, Vail, AZ (US); Matthew J. Ward, Vail, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: International Business Machines Corporation, Armonk, NY (US)

(21) Appl. No.: 12/023,871

(22) Filed: Jan. 31, 2008

(51) Int. Cl. G06F 17/30

(52) U.S. Cl. 707/10; 707/E17.032

(57) ABSTRACT

A method for storing data includes establishing a space efficient storage system including a virtual repository, a staging repository and a remote repository. The virtual repository includes a first pointer to the staging repository, and the staging repository includes a second pointer to the remote repository. The method further includes receiving data at the virtual repository, storing the received data in the staging repository based on the first pointer, and determining a data access frequency based on the storage in the staging repository. In addition, the method includes comparing the determined data access frequency to a threshold frequency and transferring the stored data to the remote repository based on the second pointer and comparison and storing the stored data at the staging repository based on the comparison.

### FIELD OF INVENTION

The present invention generally relates to storage repositories. More specifically, the invention relates to space efficient repositories.

### BACKGROUND OF THE INVENTION

Data is stored on systems, and these systems require space as well as resources to manage the storage. Historically, much data was stored on local devices, such as tape and/or hard drives and removable media. As the need for data storage increases, remote data storage increases its appeal. Remote data storage reduces local space requirements and can help improve service with dedicated resources. Remote data storage further lends itself well to a customer/vendor relationship, wherein the vendor supplies the data storage to the customer.

As customer storage becomes more and more focused on archival storage and the necessity to reduce storage floor space/energy usage, off-site (leased) storage becomes more and more of a desirable option. However, customers still (and will always) have a requirement to have existing storage on site for performance and security reasons. Unfortunately any solution to have both on-site and off-site storage would require the system administrator to have to learn how to deal with both architectures, which are, inevitably, disparate in their operational procedures.

While remote storage offers advantages in space utilization, and can offer cost advantages, remote storage suffers from communications latency occasioned by the number of systems the data must traverse, as well as latency due to the distance traveled by the signals. If a user device in the United States is attempting to access remote storage in the Far East, numerous signals must traverse numerous systems, and traverse a great geographical distance, undesirably delaying the speed of response. This latency presents a significant tradeoff to the advantages of remote storage.

It is therefore a challenge to develop strategies for data storage to overcome these, and other, disadvantages.

### SUMMARY OF THE INVENTION

One embodiment of the invention provides a method for storing data that includes establishing a space efficient storage system including a virtual repository, a staging repository and a remote repository. The virtual repository includes a first pointer to the staging repository, and the staging repository includes a second pointer to the remote repository. The method further includes receiving data at the virtual repository, storing the received data in the staging repository based on the first pointer, and determining a data access frequency based on the storage in the staging repository. In addition, the method includes comparing the determined data access frequency to a threshold frequency and transferring the stored data to the remote repository based on the second pointer and comparison and storing the stored data at the staging repository based on the comparison.

Another embodiment of the present invention is a computer readable medium holding computer readable code for storing data. The medium includes code for establishing a space efficient storage system including a virtual repository, a staging repository and a remote repository. The virtual repository includes a first pointer to the staging repository, and the staging repository includes a second pointer to the remote repository. The medium further includes code for receiving data at the virtual repository, code for storing the received data in the staging repository based on the first pointer, and code for determining a data access frequency based on the storage in the staging repository. In addition, the medium includes code for comparing the determined data access frequency to a threshold frequency and code for transferring the stored data to the remote repository based on the second pointer and comparison and code for storing the stored data at the staging repository based on the comparison.

Yet another embodiment of the invention provides a system for storing data that includes means for establishing a space efficient storage system including a virtual repository, a staging repository and a remote repository. The virtual repository includes a first pointer to the staging repository, and the staging repository includes a second pointer to the remote repository. The system further includes means for receiving data at the virtual repository, means for storing the received data in the staging repository based on the first pointer, and means for determining a data access frequency based on the storage in the staging repository. In addition, the system includes means for comparing the determined data access frequency to a threshold frequency, means for transferring the stored data to the remote repository based on the second pointer and comparison and means for storing the stored data at the staging repository based on the comparison.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a data storage system in accordance with one aspect of the invention; and

FIG. 2 illustrates one embodiment of a method for storing data in accordance with another aspect of the invention.

### DETAILED DESCRIPTION OF THE PRESENT INVENTION

This invention is a method to extend the idea of space efficient storage to replace the existing repository volume with a virtual repository volume that contains a server address and metadata which points to a location on a remote storage device repository volume. The read/writes from the local machine to the remote machine are asynchronous. A staging area volume on the local storage system holds data recently written or read by a user before it has had a chance to be copied asynchronously to the remote storage system. Read/writes to a local system have reduced latency, so that staging area is used as a fast caching area storing often used data based on the user access. Increasing the size of the staging area volume in relation to the virtual repository volume, will in effect increase performance at the cost of physical space usage on the local storage system. As a note, a synchronous solution would require the remote storage to be physically close to the customer's local storage. Such a situation may be beneficial if the customer owns both boxes being used and they are both on site.

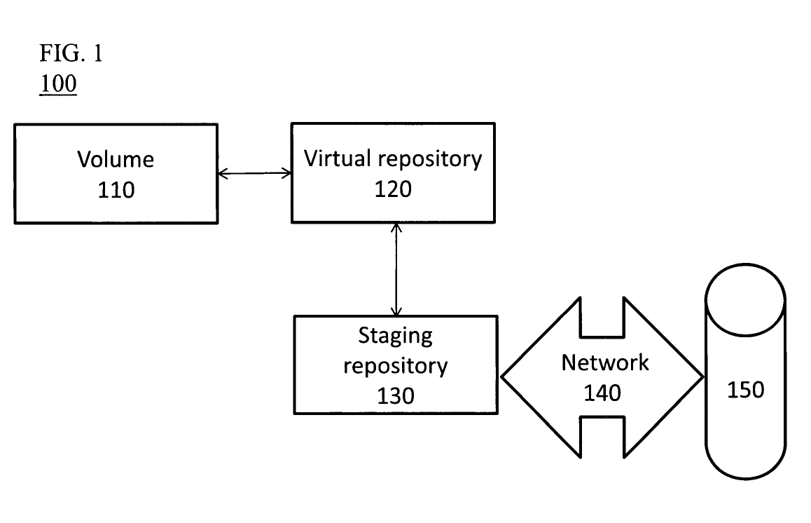

FIG. 1 illustrates one embodiment of a space efficient storage system 100, in accordance with one aspect of the invention. System 100 includes a space efficient volume 110 in communication with a virtual repository 120. Virtual repository 120 is in communication with staging repository 130. The staging repository 130 is in communication with a remote repository 150.

Space efficient repository 110 receives read and write commands from a user computing device that issues read and write commands to a non-volatile memory, such as a personal computer, PDA, laptop, MP3 player or other device. Space efficient repository 110 is a volume that reserves no physical space to hold user data directly. Space efficient repository 110 is a collection of metadata that can point to locations in the local repository, such as the virtual repository 120. If data is written/read to space efficient repository 110, the read/write is rerouted to where the data actually exists on the local system. When an initial write is done to one of the sectors of the space efficient repository 110, an allocation command is sent to the repository to reserve space on the repository so that the user data may be written. There are also commands to release such allocated repository space when it is no longer needed, or when the logical volume is removed.

Virtual repository 120 reserves no physical space on the local storage to hold user data directly. Instead, virtual repository 120 contains metadata for mapping purposes, a reference to the staging repository 130 and a host port World Wide Port Name (WWPN). The host port specified should be connected 140, either directly or indirectly, to a remote system which is set up with remote repository 150. The metadata indicates a physical location on a storage system where the user data exists, and a bit which indicates if the user data exists on the local storage system (the assigned staging repository 130) or on the remote repository 150 set up to communicate with this virtual repository 120.

Staging repository 130 holds user data temporarily when the data is either waiting to be copied to remote repository 150, or just as a caching area where recently read/written information is stored so that fewer calls to the remote repository 150 are made. Increasing the size of the staging repository 130 in relation to the virtual repository 120, will in effect increase performance at the cost of physical space usage on the local storage system. In one embodiment, the staging repository 130 is sized based on an estimation of bandwidth between the staging repository 130 and the network 140, and anticipated demand for storage throughput. In one embodiment, staging repository 130 includes an area sufficient to store S bytes of data. In one embodiment, virtual repository 120 is local to the staging repository 130 and the staging repository 130 is remote to the remote repository 150.

In one embodiment, staging repository 130 maintains a database including metadata associated with data access, and the frequency of data access. The metadata can be persistent, or can be stored for a predetermined time span, such as a week or a month. In another embodiment, the database is stored in the space efficient volume 110. In yet another embodiment, the database is maintained at the virtual repository 120. The database is constructed responsive to read/write calls issued through the space efficient volume 110 and includes a counter incremented based on each read/write for each particular data and/or file. The counter reflects the data access frequency associated with each data and/or file.

Connection 140 is a network connection providing communication between geographically separated devices. In one embodiment, connection 140 is the Internet. Connection 140 connects remote computing devices, with a user device at one end and the remote repository 150 at the other.

Remote repository 150 holds user data in a persistent, long term manner. Remote repository responds to reads, writes, allocate, and deallocate messages sent from the local server. The physical capacity of the remote repository should be exactly the same as the virtual capacity defined for the virtual repository. In one embodiment, the physical capacity of the remote repository can be adjusted with a command configured to increase and/or decrease storage allocations. In one embodiment, the remote repository includes an area sufficient to store R bytes of data. In one embodiment, S/R≦X, wherein X is a predetermined constant. In one such embodiment,

X is less than 0.10. In other embodiments, X is a negligible number such that the total storage in the staging area is a negligible number compared to the total storage in the remote repository. For example, in one embodiment, the staging repository can store 5 gigabytes, whereas the remote repository can store 5 petabytes.

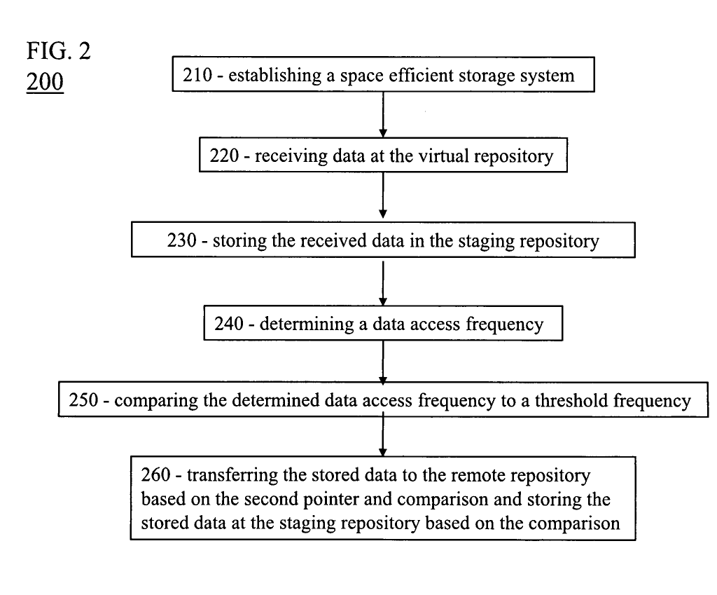

FIG. 2 illustrates one embodiment of a method 200 for storing data, in accordance with one aspect of the invention. Method 200 begins at step 210 by establishing a space efficient storage system including a virtual repository, a staging repository and a remote repository. The virtual repository includes a first pointer to the staging repository, and the staging repository includes a second pointer to the remote repository. The virtual repository receives data at step 220, and stores the received data in the staging repository based on the first pointer at step 230. In one embodiment, the virtual repository does not physically store any user data.

The data access frequency is determined based on the storage in the staging repository at step 240. The data access frequency is metadata associated with the number of times in a predetermined time span a particular data or file has been the subject of a read/write. The more commonly, either on average or in absolute terms, a particular file or data is subject of a read/write, the higher the data access frequency.

The determined data access frequency is compared to a threshold frequency at step 250. The threshold frequency is associated with a number of read/writes that is determined to affect whether the read/write data is transferred to the remote repository or maintained at the staging repository. In one embodiment, the threshold frequency is a predetermined frequency. In another embodiment, the threshold frequency is a user configured frequency. In yet another embodiment, the threshold frequency is determined responsive to a history of data access. In one such embodiment, the threshold frequency is dynamically determined so that the most accessed N number of data/files are stored at the staging repository, while the remaining files are stored at the remote repository.

In one embodiment, a remote repository command is received and the size of the remote repository is adjusted based on the remote repository command. For example, a service provider can supply customers with remote repository services sized to consumer needs. Thus, the service provider can maintain a zettabyte of storage, for example, comprising volumes of smaller storage units, such as terabytes. A consumer can subscribe for data storage, of say, 10 terabytes, and based on a request, the storage for that customer can be increased to 15 terabytes or reduced to 5 terabytes. Based on such a request, no on-site visit to the customer local storage would be required, easing the transition.

In one embodiment, the virtual repository and staging repository are disposed at a first location, and the remote repository is disposed at a second location geographically offset from the first location. Thus, the storage of data does not require storage at the staging area site, and can be sited to take advantage of real estate costs, service costs, electrical costs, or the like.

User write requests are initially handled in the staging repository to be transferred to the remote storage system at a later time. Once the write completes on the remote repository 150, an acknowledgement is sent back to the local storage system along with the physical track location where the data was written in the remote repository 150. This location is recorded in the metadata in the virtual repository 120, and finally, the user process is sent confirmation that the write competed. When the user initiates a read from the space efficient volume 110 the read is redirected to the virtual repository 120, which, in turn, is redirected (along with the known physical location of the user data) to the remote repository 150. The information is then sent back to the local storage system and returned to the user process.

While the data exists in the staging repository 130 any reads from the space efficient volume 110 for this information will not need to go over the network. There is a background thread, termed the deferred destage thread, that periodically scans the staging repository 130 and copies any outstanding information to the remote repository 150 in the remote storage system. After the data is copied, the track in the staging repository 130 is marked as available. Any future writes will still read from the staging repository 130 until it is decided by the caching algorithm that this track should be used by new incoming data. A caching algorithm can be used, such as, but not limited to, algorithms based on bandwidth properties, data security properties, time properties, or the like. Whenever the data is no longer valid in the staging area, the virtual repository 120 metadata is updated to point to the valid location in the remote repository 150.

In one embodiment, data/files are transferred for storage on the staging repository from the remote repository based on the comparison of the determined data access frequency and threshold frequency. Thus, as data read traffic changes, the system dynamically adjusts the location of the stored files/data so that the most frequently accessed data/files are stored at the staging volume. In one embodiment, data/files are transferred for storage on the staging repository from the remote repository based on the comparison of the determined data access frequency and threshold frequency, as well as the size of the data/files and staging repository storage capacity. Any less frequently accessed data/files on the staging repository are then transferred to the remote repository. This dynamic storage allocation decreases access latency.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method for storing data, the method comprising:
establishing a space efficient storage system including a virtual repository, a staging repository and a remote repository, wherein the virtual repository includes a first pointer to the staging repository, and wherein the staging repository includes a second pointer to the remote repository;
receiving data at the virtual repository;
storing the received data in the staging repository based on the first pointer;
determining a data access frequency based on the storage in the staging repository;
comparing the determined data access frequency to a threshold frequency; and
transferring the stored data to the remote repository based on the second pointer and comparison and storing the stored data at the staging repository based on the comparison.

2. The method of claim 1 wherein the threshold frequency is a predetermined frequency.

3. The method of claim 1 wherein the threshold frequency is determined responsive to a history of data access.

4. The method of claim 1 wherein the staging repository includes an area sufficient to store S bytes of data, and wherein the remote repository includes an area sufficient to store R bytes of data, and wherein S/R≦X, wherein X is a predetermined constant.

5. The method of claim 4 wherein X is less than 0.10.

6. The method of claim 1 further comprising:
receiving a remote repository command; and
adjusting a size of the remote repository based on the remote repository command.

7. The method of claim 1 wherein the virtual repository receives data from a space efficient volume, the space efficient volume containing no physical space for data storage.

8. The method of claim 1 wherein the virtual repository is local to the staging repository and wherein the staging repository is remote to the remote repository.

9. The method of claim 8 wherein the virtual repository and staging repository are disposed at a first location, and wherein the remote repository is geographically offset from the first location.

10. A computer readable medium including computer readable code for storing data, the medium comprising:
computer readable code for establishing a space efficient storage system including a virtual repository, a staging repository and a remote repository, wherein the virtual repository includes a first pointer to the staging repository, and wherein the staging repository includes a second pointer to the remote repository;
computer readable code for receiving data at the virtual repository;
computer readable code for storing the received data in the staging repository based on the first pointer;
computer readable code for determining a data access frequency based on the storage in the staging repository;
computer readable code for comparing the determined data access frequency to a threshold frequency; and
computer readable code for transferring the stored data to the remote repository based on the second pointer and comparison and storing the stored data at the staging repository based on the comparison.

11. The medium of claim 10 wherein the threshold frequency is a predetermined frequency.

12. The medium of claim 10 wherein the threshold frequency is determined responsive to a history of data access.

13. The medium of claim 10 wherein the staging repository includes an area sufficient to store S bytes of data, and wherein the remote repository includes an area sufficient to store R bytes of data, and wherein S/R≦X, wherein X is a predetermined constant.

14. The medium of claim 13 wherein X is less than 0.10.

15. The medium of claim 10 further comprising:
computer readable code for receiving a remote repository command; and
computer readable code for adjusting a size of the remote repository based on the remote repository command.

16. The medium of claim 10 wherein the virtual repository receives data from a space efficient volume, the space efficient volume containing no physical space for data storage.

17. The medium of claim 16 wherein the virtual repository and staging repository are disposed at a first location, and wherein the remote repository is geographically offset from the first location.

18. A system for storing data, the medium comprising:
means for establishing a space efficient storage system including a virtual repository, a staging repository and a remote repository, wherein the virtual repository includes a first pointer to the staging repository, and wherein the staging repository includes a second pointer to the remote repository;
means for receiving data at the virtual repository;
means for storing the received data in the staging repository based on the first pointer;
means for determining a data access frequency based on the storage in the staging repository;
means for comparing the determined data access frequency to a threshold frequency; and
means for transferring the stored data to the remote repository based on the second pointer and comparison and storing the stored data at the staging repository based on the comparison.
